(19) United States
(12) Patent Application Publication
(10) Pub. No.: US 2013/0227608 A1
(43) Pub. Date: Aug. 29, 2013

(54) LATE-BINDING OF ADVERTISEMENTS USING RDMA CONNECTIVITY

(71) Applicant: Qurio Holdings, Inc., (US)

(72) Inventors: Gregory Morgan Evans, Raleigh, NC (US); Alfredo C. Issa, Apex, NC (US); Richard J. Walsh, Raleigh, NC (US)

(73) Assignee: Qurio Holdings, Inc., Raleigh, NC (US)

(21) Appl. No.: 13/861,680

(22) Filed: Apr. 12, 2013

Related U.S. Application Data
(63) Continuation of application No. 11/685,479, filed on Mar. 13, 2007, now abandoned.

(51) Int. Cl. H04N 21/234

(52) U.S. Cl. CPC H04N 21/23424
USPC 725/35

(57) ABSTRACT

A system and method are provided for inserting customized or personalized advertisements into video content presented to a viewer. In general, the system includes an ad content server and a late-binding ad insertion system serving a number of client devices including a client device of the viewer. Utilizing Remote Direct Memory Access (RDMA), the late-binding ad insertion system obtains customized advertisements for the viewer from the ad content server. The late-binding ad insertion system then provides the video content having the customized advertisements inserted therein to the client device for presentation to the viewer.

### RELATED APPLICATION

This patent application is a continuation of co-pending U.S. patent application Ser. No. 11/685,479, filed on Mar. 13, 2007, entitled LATE-BINDING OF ADVERTISEMENTS USING RDMA CONNECTIVITY, which is hereby incorporated herein by reference in its entirety.

### TECHNICAL FIELD

The present invention relates to late-binding of advertisements in a content distribution system such as, but not limited to, a television content distribution system.

### BACKGROUND

Targeted or narrowcast advertising provides an effective model for merchants to reach consumers. For example, a business selling children's apparel can benefit from narrowcast ad distribution by limiting its advertising to parents. As another example, advertisements may be matched with content being viewed and preferences of the viewer in order to provide a personalized viewing experience. Additionally, late-binding of advertisements may be combined with narrowcasting to provide even greater value to the consumer and merchant. With late-binding, advertisements are matched to and inserted into content during playback. As such, the times at which advertisements are presented and the number of times that an advertisement is presented can easily be controlled.

One issue with narrowcasting and late-binding of advertisements is that current digital cable television, satellite television, and Internet Protocol Television (IPTV) architectures do not efficiently scale to accommodate late-binding of narrowcast advertisements as the narrowcasting becomes more targeted and the number of users grows. As such, there is a need for a system and method providing efficient late-binding of narrowcast advertisements in a digital cable television, satellite television, IPTV system, or the like.

### SUMMARY

The present invention provides a system and method for inserting customized or personalized advertisements, or ads, into video content provided to a viewer. In general, the system includes an ad content server and a late-binding ad insertion system serving a number of client devices including a client device of the viewer. Utilizing Remote Direct Memory Access (RDMA), the late-binding ad insertion system obtains customized advertisements for the viewer from the ad content server. The late-binding ad insertion system then provides the video content having the customized advertisements inserted therein to the client device for presentation to the viewer.

More specifically, the ad content server stores an advertisement in associated storage for each of a number of defined advertisement categories and publishes a mapping including information describing the advertisement categories and information identifying locations of the associated advertisements in the associated storage of the ad content server to the late-binding ad insertion system. Thereafter, when an advertisement is needed for insertion into video content being viewed or to be viewed by the viewer, the late-binding ad insertion system selects one of the advertisement categories based on a comparison of the information describing the advertisement categories and, for example, information describing the video content, information describing the viewer and/or the viewing habits of the viewer, or the like. The late-binding ad insertion system then initiates an RDMA transfer of the advertisement associated with the selected advertisement category from the associated storage of the ad content server to an advertisement buffer of the late-binding ad insertion system associated with a digital video channel serving the video content to the client device of the viewer. The advertisement from the ad buffer is then inserted into the video content, and the video content having the advertisement inserted therein is provided to the viewer via the digital video channel.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates a system incorporating a number of ad content servers and late-binding ad insertion systems wherein advertisements are transferred from the ad content servers to the late-binding ad insertion systems utilizing Remote Direct Memory Access (RDMA) transfers according to one embodiment of the present invention;

FIGS. 2A and 2B illustrate the operation of the system of FIG. 1 according to one embodiment of the present invention;

FIG. 3 is a flow chart illustrating the operation of one of the ad content servers of FIG. 1 according to one embodiment of the present invention; and

FIG. 4 is a flow chart illustrating the operation of one of the late-binding ad insertion systems of FIG. 1 according to one embodiment of the present invention.

### DETAILED DESCRIPTION

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

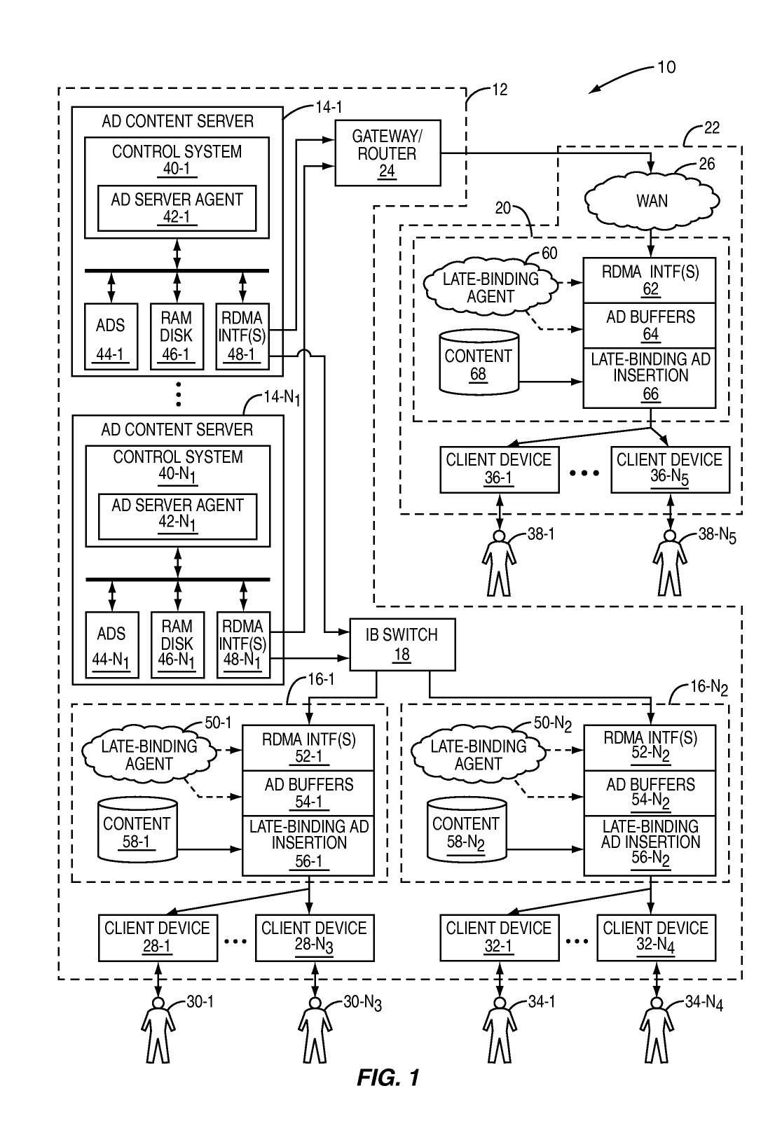

FIG. 1 illustrates a system 10 providing substantially real-time late-binding of customized or personalized advertisements into video content provided to viewers according to one embodiment of the present invention. A central head-end 12 includes a number of ad content servers 14-1 through 14-N₁ and a number of late-binding ad insertion systems 16-1 through 16-N₂ (hereinafter referred to as “ad insertion systems”). The ad content servers 14-1 through 14-N₁ and the ad insertion systems 16-1 through 16-N₂ are connected via a Local Area Network (LAN) technology, which in this embodiment is an Infiniband (IB) switch 18 for purposes of transferring advertisements, or ads, from the ad content servers 14-1 through 14-N₁ to the ad insertion systems 16-1 through 16-N₂ as discussed below in detail. While not shown for clarity, the ad content servers 14-1 through 14-N₁ and the ad insertion systems 16-1 through 16-N₂ may additionally be connected by LAN technology such as an Ethernet switch for other types of communication. For example, as discussed below, the ad content servers 14-1 through 14-N₁ may publish memory maps enabling Remote Direct Memory Access (RDMA) transfers of advertisements to the ad insertion systems 16-1 through 16-N₂ via an Ethernet LAN.

The system 10 may also include a remote ad insertion system 20 located at a remote head-end 22. The remote ad insertion system 20 is connected to the ad content servers 14-1 through 14-N₁ via a gateway or router 24 and a Wide Area Network (WAN) 26. The WAN 26 may be any type of WAN such as, for example, the Internet.

The ad insertion system 16-1 serves a number of client devices 28-1 through 28-N₃ having associated users or viewers 30-1 through 30-N₃. Each of the client devices 28-1 through 28-N₃ may be, for example, a set-top boxes, a video card in a set-top box, a video card in a personal computer, a mobile device, or the like. In one embodiment, each of the client devices 28-1 through 28-N₃ receives video content, or audio-visual content, having customized advertisements inserted therein from the ad insertion system 16-1 via a digital video channel such as a Secure Digital Video (SDV) channel. The video content may Video-on-Demand (VOD) content, broadcast television content, Internet Protocol Television (IPTV) content, video content recorded by personal Digital Video Recorder (DVR) functions of the viewers 30-1 through 30-N₃ hosted at the central head-end 12, or the like.

In one embodiment, each of the client devices 28-1 through 28-N₃ is assigned a separate SDV channel. However, the present invention is not limited thereto. In one embodiment, a subset of the viewers 30-1 through 30-N₃ that are viewing the same video content and are related by, for example, demographics, viewing preferences, viewing history, or the like may be identified and served by a single SDV channel. Note that while SDV channels are discussed herein, the present invention is not limited thereto. One of ordinary skill in the art will recognize that other types of communication channels may be used. For example, an IPTV channel may alternatively be used.

Like the ad insertion system 16-1, the ad insertion system 16-N₂ serves a number of client devices 32-1 through 32-N₄ having associated viewers 34-1 through 34-N₄, and the remote ad insertion system 20 serves a number of client devices 36-1 through 36-N₅ having associated viewers 38-1 through 38-N₅. Note that N₁ through N₅ may each be any integer greater than or equal to 1.

The ad content server 14-1 generally includes a control system 40-1 including an ad server agent 42-1. In addition, the ad content server 14-1 includes an advertisement database 44-1, a Random Access Memory Disk (RAM disk) 46-1, and one or more RDMA network interfaces 48-1. The ad server agent 42-1 may be implemented in software, hardware, or a combination of software and hardware.

The advertisement database 44-1 includes a number of advertisements, metadata or information describing the advertisements, and optionally an identifier (ID) for each of the advertisements. The advertisements may be audio-visual, audio, or visual advertisements that are inserted into breaks in video content defined by advertisement slots such as, for example, television commercials; audio-visual, audio, or visual content overlaid onto video content during an advertisement period or slot; or the like. For example, an advertisement may be a traditional commercial for a particular automobile or automobile manufacturer. As another example, an advertisement may be a logo for an automobile manufacturer that is to be overlaid on the video content during an advertisement slot or period.

The RAM disk 46-1 is generally a virtual solid state disk formed by RAM. According to one embodiment of the present invention, the ad server agent 42-1 operates to store or initiate storage of an advertisement for each of a number of advertisement categories in the RAM disk 46-1. The ad server agent 42-1 may update or rotate new advertisements for the advertisement categories or advertisements for new advertisement categories into the RAM disk 46-1. The access time of the RAM disk 46-1 is substantially less than the access time of traditional hard-disk drives. As such, by storing the advertisements in the RAM disk 46-1, the time required for the RDMA transfers of the advertisements to the ad insertion systems 16-1 through 16-N₂ and 20 is substantially less than the time required for an RDMA transfer from a traditional hard-disk drive. However, the present invention is not limited to the use of the RAM disk 46-1. Preferably, any non-volatile or volatile storage device having relatively fast transfer times as compared to traditional hard-disk drives may be used. For example, flash memory may alternatively be used. Further, in an alternative embodiment, the advertisement database 44-1 including the advertisements may be stored on one or more solid state devices such as one or more hard-disk drives. The advertisements may then be transferred from the solid state devices to the ad insertion systems 16-1 through 16-N₂ and 20 utilizing RDMA. Note that the advertisement categories may still be used.

The following example illustrates the benefit of using the RAM disk 46-1 over traditional hard disk drives. Using RDMA over a 10 Gb/s IB link and assuming an 8/10 coding overhead, a 37.5 Mbyte file (or 30-second High-Definition (HD) video ad) may be transferred from, for example, the RAM disk 46-1 to an ad buffer at the ad insertion system 16-1 in less than 38 milliseconds. This would scale to approximately 26 HD 30-second commercials being delivered from the ad content server 14-1, or each 10 G IB port of the ad content server 14-1, per second. In comparison, if a hard disk drive supporting a 70 Mbyte/second Internal Sustained Transfer Rate (STR) was used, the ad content server 14-1, or each IB port of the ad content server 14-1, would provide less than two commercials per second. Using a heavy commercial rate of 20 minutes per hour (40 commercials per hour) for prime time, the ad content server 14-1 utilizing the RAM disk 46-1 could support per viewer or viewer group narrowcast for 2340 separate SDV channels. This compares to a maximum of 168 SDV channels from a hard disk drive operating at the 70 Mbyte/second STR. Further note that the fast access time provided by the RAM disk 46-1 enables real-time or substantially real-time late-binding of advertisements to video content at the ad insertion systems 16-1 through 16-N₂ and 20.

The RDMA network interface 48-1 enables RDMA transfers from the RAM disk 46-1 to the ad insertion systems 16-1 through 16-N₂ via the IB switch 18. In addition, either the same RDMA network interface 48-1 or another RDMA network interface 48-1 enables RDMA transfers from the RAM disk 46-1 to the remote ad insertion system 20 via the WAN 26. In the preferred embodiment, the RDMA network interface 48-1 operates according to the Internet Wide Area RDMA Protocol (iWARP) or the RDMA over Transmission Control Protocol/Internet Protocol (TCP/IP) protocol to enable RDMA transfers via the WAN 26.

Like the ad content server 14-1, the ad content server 14-N₁ includes a control system 40-N₁ having an ad server agent 42-N₁, an advertisement database 44-N₁, a RAM disk 46-N₁, and one or more RDMA network interfaces 48-N₁.

The ad insertion system 16-1 includes a late-binding agent 50-1, an RDMA network interface 52-1, a number of ad buffers 54-1, and a late-binding ad insertion function 56-1. The late-binding agent 50-1 may be implemented in software, hardware, or a combination of software and hardware. In general, the late-binding agent 50-1 utilizes RDMA to transfer advertisements from the ad content servers 14-1 through 14-N₁ to the ad buffers 54-1 when advertisements are needed for video content presented or to be presented over the SDV channels of the client devices 28-1 through 28-N₃ or a related group of the client devices 28-1 through 28-N₃.

The RDMA network interface 52-1 is a network interface enabling RDMA transfers via a LAN. In this embodiment, the RDMA network interface 52-1 is a network interface enabling RDMA transfers via the IB switch 18. The ad buffers 54-1 may be implemented using memory such as, for example, RAM. In one embodiment, there is a one-to-one correspondence between the ad buffers 54-1 and the SDV channels used to provide video content to the client devices 28-1 through 28-N₃ where each SDV channel has an associated ad buffer. However, the present invention is not limited thereto. Alternatively, the ad buffers 54-1 may include multiple ad buffers for each of the SDV channels.

The late-binding ad insertion function 56-1 may be implemented in software, hardware, or a combination of software and hardware. In operation, the late-binding ad insertion function 56-1 operates to insert advertisements transferred to the ad buffers 54-1 into the video content delivered to the client devices 28-1 through 28-N₃ from a content source 58-1. The content source 58-1 may be a local database of content, a remote source of content, or the like. Again, the video content may be, for example, VOD content, video content stored by a DVR function of the central head-end 12 or associated system on behalf of the viewers 30-1 through 30-N₃, broadcast video content such as traditional broadcast or cable television programs, or the like.

Similarly, the ad insertion system 16-N₂ includes a late-binding agent 50-N₂, an RDMA network interface 52-N₂, ad buffers 54-N₂, and a late-binding ad insertion function 56-N₂. As discussed above, the late-binding ad insertion function 56-N₂ operates to insert advertisements from the ad buffers 54-N₂ into video content delivered to the client devices 32-1 through 32-N₄ from a content source 58-N₂ via associated SDV channels. The content source 58-N₂ may or may not be the same content source for the ad insertion system 16-1.

The remote ad insertion system 20 is similar to the ad insertion systems 16-1 through 16-N₂. The remote ad insertion system 20 includes a late-binding agent 60, an RDMA network interface 62, ad buffers 64, and a late-binding ad insertion function 66. For the remote ad insertion system 20, the RDMA interface 62 enables RDMA transfers via the WAN 26. In one embodiment, the RDMA interface 62 operates according to the iWARP or RDMA over TCP/IP standard. As discussed above, the late-binding ad insertion function 66 operates to insert advertisements from the ad buffers 64 into video content delivered to the client devices 36-1 through 36-N₅ from a content source 68 via associated SDV channels. The content source 68 may or may not be the same content source for the ad insertion systems 16-1 through 16-N₂.

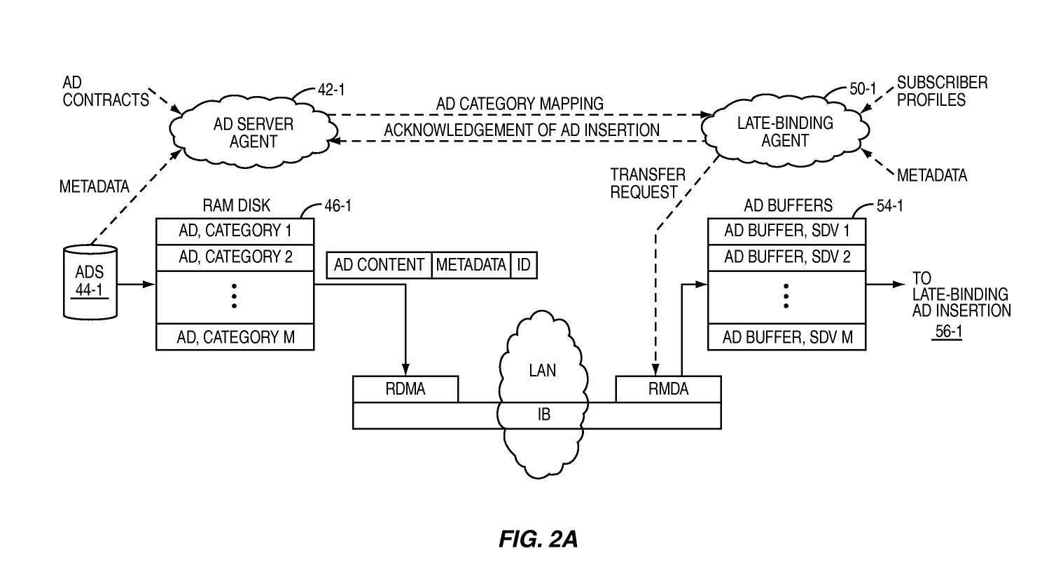

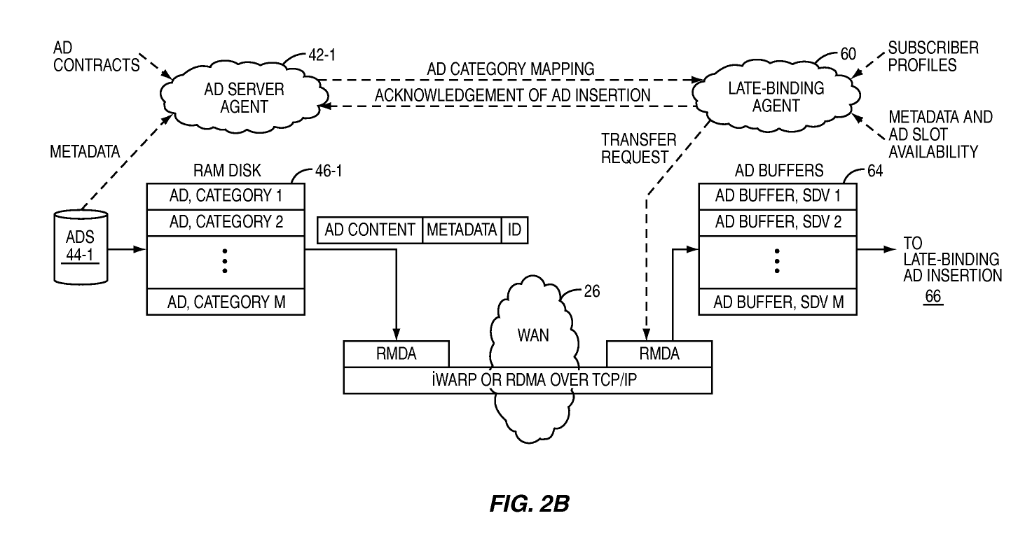

FIGS. 2A and 2B illustrate the operation of the system 10 according to one embodiment of the present invention. FIG. 2A illustrates a

LAN based transfer of advertisements from the RAM disk 46-1 of the ad content server 14-1 to the ad buffers 54-1 of the ad insertion system 16-1. Note that this discussion is equally applicable to the other ad content servers 14-2 through 14-N₁ and the other ad insertion systems 16-2 through 16-N₂. In operation, the ad server agent 42-1 generates or otherwise provides the advertisement categories. In one embodiment, the advertisement categories are defined by an operator of the system 10. In another embodiment, the ad server agent 42-1 generates the advertisement categories based on advertisement contracts, metadata or information describing the advertisements in the advertisements database 44-1, and optionally information describing all of the viewers 30-1 through 30-N₃, 34-1 through 34-N₄, and 38-1 through 38-N₅ in the system 10 or ones of the viewers 30-1 through 30-N₃, 34-1 through 34-N₄, and 38-1 through 38-N₅ that are currently or have recently viewed video content and/or viewing habits of those viewers.

An advertisement contract may include information regarding the associated vendor, times at which the associated advertisement may be viewed, a maximum number of times that the advertisement may be viewed, terms of payment for each viewing of the advertisement, an expiration date or aging out period, specific video content during which the ad is to be inserted, and the like. The ad contract may additionally include the metadata or a portion of the metadata for the associated advertisement. The metadata or information describing the associated advertisement, which is generally stored in the advertisement database 44-1, may include, for example, information defining a format of the associated advertisement such as advertisement type (audio/visual, overlay, etc.), play length, file type, and the like; advertisement rating (G, PG, PG-13, R, etc.); information describing a target audience for the associated advertisement such as demographic or biographical information; and information describing the content of the advertisement. The information describing the content of the advertisement may vary depending on the type of advertisement. For example, if the advertisement is a commercial for an automobile, the information describing the content of the advertisement may include information identifying the commercial as an automobile commercial and information identifying a manufacturer, make, and model of the automobile.

Once the advertisement categories are defined, the ad server agent 42-1 transfers or initiates transfer via, for example, Direct Memory Access (DMA) of an advertisement for each of the advertisement categories to the RAM disk 46-1. While in this embodiment only one advertisement is stored in the RAM disk 46-1 for each advertisement category, the present invention is not limited thereto. Further, if the RAM disk 46-1 cannot store advertisements for all of the advertisement categories, the ad server agent 42-1 may rotate the advertisement categories in and out of the RAM disk 46-1 during operation such that advertisements for each of the advertisement categories are utilized. Alternatively, the ad server agent 42-1 may combine similar advertisement categories in order to reduce the number of advertisement categories to a number that can be accommodated by the RAM disk 46-1.

The ad server agent 42-1 then publishes or sends a memory map to the late-binding agent 50-1 via a multicast or unicast communication channel. For each advertisement category, the memory map includes metadata or information describing the advertisement category and information identifying the location of the associated advertisement in the RAM disk 46-1.

For each of the SDV channels, the late-binding agent 50-1 or some function associated with the late-binding agent 50-1, such as the late-binding ad insertion function 56-1, detects when an advertisement is needed for the SDV channel. For example, the late-binding agent 50-1 or some associated function may process the video content or metadata associated with the video content to identify predefined advertisement slots or to identify points or segments of the video content that are well-suited for advertisements. When an advertisement is needed for an SDV channel, the late-binding agent 50-1 selects a desired advertisement category from the memory map obtained from the ad server agent 42-1. The late-binding agent 50-1 may select the desired advertisement category based on the metadata describing the advertisement categories from the memory map, metadata describing the video content being viewed over the SDV channel, a viewer profile of the viewer of the SDV channel or viewer profiles of a related group of viewers of the SDV channel, or any combination thereof. A viewer profile may include demographic information describing the viewer, biographical information describing the viewer, information identifying or describing advertisements previously viewed by the viewer, information identifying or describing video content previously viewed by the viewer, or the like. For example, the advertisement categories may include a beer commercial category, an athletic wear category, an automobile category, and a PG movie advertisement category. Thus, if the viewer 30-1 is a 13-year-old male watching a sporting event, the late-binding agent 50-1 may select the athletic wear category for the associated SDV channel. In contrast, if the same viewer 30-1 is watching a movie, the late-binding agent 50-1 may select the PG movie advertisement category.

Using the SDV channel viewed by the user 30-1 as an example, once the desired advertisement category is selected, the late-binding agent 50-1 initiates an RDMA transfer of the associated advertisement from the RAM disk 46-1 to the ad buffer for the SDV channel using the information identifying the location of the advertisement in the RAM disk 46-1 from the memory map. The information identifying the location of the advertisement in the RAM disk 46-1 may include, for example, a starting address and an ending address defining a block of memory in the RAM disk 46-1 storing the advertisement. Once initiated, the advertisement and optionally all or a portion of the metadata describing the advertisement and an identifier (ID) of the advertisement are transferred to the ad buffer for the SDV channel utilizing RDMA. Note that the metadata describing the particular advertisement may be used during a filtering process. The filtering process may utilize filtering criteria defined by the viewer 30-1 or, for example, a parent of the viewer 30-1. For example, if the viewer 30-1 is a minor child, filtering criteria may be defined such that beer commercials, R-rated advertisements, or the like are not inserted into video content being viewed by the viewer 30-1. Once transferred to the ad buffer for the SDV channel, the advertisement is inserted into the video content prior to or as the video content is provided to the client device 28-1 via the SDV channel.

After inserting the advertisement into the video content, the late-binding agent 50-1 sends an acknowledgement to the ad server agent 42-1. The acknowledgement includes the ID or other information identifying the advertisement. In addition, the acknowledgement may include information identifying or describing the viewer 30-1 such as, for example, demographic and/or biographical information; a time at which the advertisement was viewed; information describing or identifying the video content into which the advertisement was inserted; or the like. Still further, if the viewer 30-1 is permitted to fast-forward through the advertisement, skip the advertisement, or otherwise choose not to view the advertisement, the acknowledgement may include information regarding or indicating whether the viewer 30-1 viewed the advertisement and, if so, how much of the advertisement was viewed, the length of time that the advertisement was viewed, and/or what section(s) of the advertisement was viewed.

The acknowledgment may then be used by the ad server agent 42-1 to determine whether contractual obligations for the advertisement have fully or partially been fulfilled. In addition, the ad server agent 42-1 may use the acknowledgment to determine whether to replace the advertisement with a new advertisement for the associated advertisement category in the RAM disk 46-1.

FIG. 2B is similar to FIG. 2A and illustrates a WAN based transfer of advertisements from the RAM disk 46-1 of the ad content server 14-1 to the ad buffers 64 of the remote ad insertion system 20. For conciseness, the details of FIG. 2B, which are substantially the same as those for FIG. 2A, will not be repeated. However, as illustrated in FIG. 2B, the RDMA transfer is performed over the WAN using iWARP, RDMA over TCP/IP, or similar technology. For both iWARP and RDMA over TCP/IP, IP based routing is needed. Also, note that additional protocol layers above the

RDMA layer such as, for example, ISCSI (Internet Small Computer System Interface) may be desired.

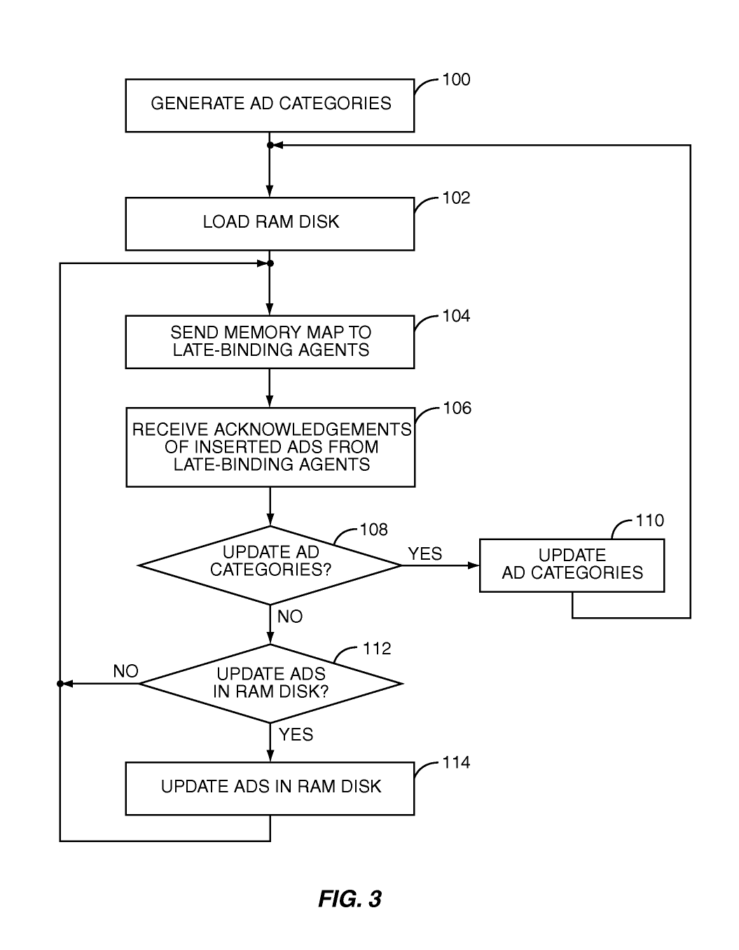

FIG. 3 is a flow chart illustrating the operation of the ad content server 14-1 according to one embodiment of the present invention. Note that the following discussion is equally applicable to the other ad content servers 14-2 through 14-N₁. First, the ad content server 14-1, and more specifically the ad server agent 42-1, generates the advertisement categories (step 100). Alternatively, the advertisement categories may be defined by an operator of the system 10. Next, the ad content server 14-1 loads the RAM disk 46-1 with advertisements for at least a portion of the advertisement categories (step 102). More specifically, in one embodiment, the ad content server 14-1 transfers or initiates the transfer of one advertisement for each of the advertisement categories or a number of the advertisement categories to the RAM disk 46-1. The ad content server 14-1 then generates and sends a memory map to one or more of the late-binding agents 50-1 through 50-N₂ and 60 (step 104). The ad content server 14-1 may send the memory map to one or more of the late-binding agents 50-1 through 50-N₂ via separate unicast communication channels or a single multicast communication channel. Note that the late-binding agents 50-1 through 50-N₂ desiring to receive the memory map may be required to register with the ad content server 14-1.

Thereafter, utilizing RDMA, advertisements are transferred to the ad buffers 54-1 through 54-N₂ and 64 of the ad insertion systems 16-1 through 16-N₂ and 20 as desired. By using RDMA, the transfers are transparent to the control system 40-1 including the ad server agent 42-1. As advertisements are inserted into video content at the ad insertion systems 16-1 through 16-N₂ and 20, acknowledgements are provided to the ad content server 14-1 and received by the ad server agent 42-1 (step 106).

At some point, the ad server agent 42-1 determines whether to update the advertisement categories (step 108). The advertisement categories may be updated based on time of day, day of the week, month of the year, or the like. In addition or alternatively, the advertisement categories may be updated if there are more advertisement categories than can be accommodated by the RAM disk 46-1 at one time. In such a situation, the ad server agent 42-1 may update the advertisement categories for which advertisements are stored in the RAM disk 46-1 such that all advertisement categories are utilized and/or advertisement contracts are fulfilled. In addition or alternatively, if the advertisement categories are automatically generated, the advertisement categories may additionally or alternatively be updated if there is a significant change in the advertisement contracts, the advertisements in the advertisement database 44-1, and/or the viewer profiles of the viewers 30-1 through 30-N₃, 34-1 through 34-N₄, and 38-1 through 38-N₅ of the system 10.

If the advertisement categories need to be updated, the ad server agent 42-1 updates the advertisement categories (step 110) and the process returns to step 102 in order to load the RAM disk 46-1 with advertisements for the updated advertisement categories. From this point, the process repeats.

If the advertisement categories do not need to be updated, the ad server agent 42-1 determines whether to update the advertisements for the advertisement categories stored in the RAM disk 46-1 (step 112). The advertisements for the advertisement categories stored in the RAM disk 46-1 may be updated by replacing the advertisements with other advertisements from the advertisement database 44-1 periodically, in such a manner as to fulfill contractual obligations, or the like. If the advertisements do not need to be updated, the process returns to step 104. If the advertisements need to be updated, the ad server agent 42-1 updates the advertisements for the advertisement categories or a number of the advertisement categories stored in the RAM disk 46-1 (step 114). More specifically, for each advertisement category for which the associated advertisement is to be updated, the ad server agent 42-1 selects another advertisement from a group of advertisements stored in the advertisement database 44-1 that are within or satisfy criteria for that advertisement category. The selected advertisement is then stored in the RAM disk 46-1 in the location previously occupied by the previous advertisement for the advertisement category. In one embodiment, the advertisements are sized such that updating the advertisements does not require updating of the memory map. After the advertisements are updated, the process returns to step 104.

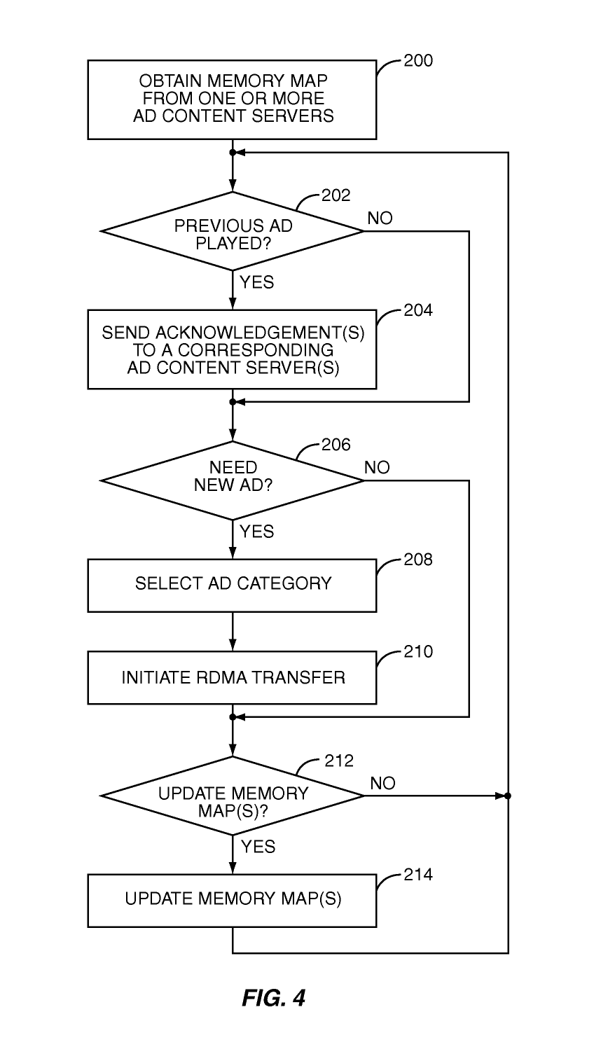

FIG. 4 is a flow chart illustrating the operation of the late-binding agent 50-1 of the ad insertion system 16-1 with respect to one of the SDV channels served by the ad insertion system 16-1 according to one embodiment of the present invention. This process is additionally performed for each of the other SDV channels served by the ad insertion system 16-1.

Further, note that this discussion is equally applicable to the late-binding agents 50-2 through 50-N₂ and 60 of the ad insertion systems 16-2 through 16-N₂ and 20.

First, the late-binding agent 50-1 obtains a memory map from one or more of the ad content servers 14-1 through 14-N₁ (step 200). Note that, in one embodiment, the ad content servers 14-1 through 14-N₁ host different advertisements. As such, the late-binding agent 50-1 may obtain memory maps from all of the ad content servers 14-1 through 14-N₁, from one of the ad content servers 14-1 through 14-N₁, or from select ones of the ad content servers 14-1 through 14-N₁. In one embodiment, the ad content servers 14-1 through 14-N₁ publish their memory maps via multicast channels, where the late-binding agent 50-1 registers with one or more of the multicast channels. In another embodiment, the ad content servers 14-1 through 14-N₁ publish their memory maps via unicast channels.

Using the SDV channel associated with the viewer 30-1 of the client device 28-1 as an example, the late-binding agent 50-1 then determines whether a previous advertisement from the ad buffer of the SDV channel has been played or viewed by the viewer 30-1 (step 202). Note that step 202 may not be desired during the first iteration through the loop. If the previous advertisement has been viewed, the late-binding agent 50-1 sends an acknowledgement to the ad content server 14-1, 14-N₁ from which the previous advertisement was obtained (step 204).

In this embodiment, after the acknowledgement is sent or if the previous advertisement has not been viewed, the late-binding agent 50-1 determines whether a new advertisement is needed for the video content being provided or to be provided to the client device 28-1 of the viewer 30-1 via the SDV channel (step 206). A new advertisement may be needed when, for example, there is an upcoming advertisement slot in the video content. If an advertisement is needed, the late-binding agent 50-1 selects a desired advertisement category from the advertisement categories in the one or more memory maps obtained in step 200 (step 208). As discussed above, the desired advertisement category may be selected based on the metadata describing the advertisement categories in the memory map(s), metadata describing the video content being viewed or to be provided over the SDV channel, one or more viewer profiles of the viewers of the SDV channel, or any combination thereof.

Once the advertisement category is selected, the late-binding agent 50-1 interacts with the RDMA network interface 52-1 to initiate an RDMA transfer of the advertisement for the desired advertisement category from the

RAM disk 46-1, 46-N₁ of the corresponding ad content server 14-1, 14-N₁ to the ad buffer of the SDV channel (step 210). More specifically, the memory map includes the information identifying the location of the advertisement in the RAM disk 46-1, 46-N₁. As such, the late-binding agent 50-1 initiates transfer of the advertisement from the identified location in the RAM disk 46-1, 46-N₁ to the ad buffer of the SDV channel. Once the transfer is initiated, the RDMA transfer is performed by the RDMA network interface 52-1 in a manner that is transparent to the late-binding agent 50-1. As a result, the advertisement is stored in the ad buffer when needed by the ad insertion function 56-1. More specifically, the ad insertion function 56-1 obtains the advertisement from the ad buffer and inserts the advertisement into the corresponding ad slot in the video content. As a result, the video content having the advertisement inserted therein is presented to the viewer 30-1 at the client device 28-1 via the SDV channel.

After initiating the RDMA transfer or if a new advertisement is not needed (step 206), the late-binding agent 50-1 may then determine whether to update the memory map(s) (step 212). If so, the late-binding agent 50-1 updates the memory map(s) (step 214). For example, the late-binding agent 50-1 may receive a memory map from the ad content server 14-1 and determine whether it has been updated using a time-stamp of the memory map. If the memory map is updated, the new memory map is stored. At this point, whether or not the memory map was updated, the process returns to step 202. The process is repeated such that customized advertisements are inserted into each advertisement slot in the video content provided to the viewer 30-1 via the SDV channel.

The present invention provides substantial opportunity for variation without departing from the spirit or scope of the present invention. For example, while the discussion above focuses on a video content distribution system, the present invention is not limited thereto. The present invention may be implemented in an audio content distribution system wherein customized or personalized advertisements are inserted into audio content such as a radio programming by a late-binding ad insertion system.

Those skilled in the art will recognize improvements and modifications to the preferred embodiments of the present invention. All such improvements and modifications are considered within the scope of the concepts disclosed herein and the claims that follow.

What is claimed is:

1. A centralized scalable method for efficiently delivering advertisements to a plurality of ad insertion systems for substantially real-time late-binding to Internet Protocol television (IPTV) content comprising:
transmitting via a multicast communication channel to the plurality of ad insertion systems a memory map including a first advertisement category with first category metadata and a random access memory (RAM) disk location;
receiving a request to register with the multicast communication channel from one of the plurality of ad insertion systems;
completing a remote direct memory access (RDMA) transfer from an advertisement database to the RAM disk location a first advertisement including advertisement content, advertising metadata, and an advertisement ID;
receiving an RDMA transfer request for the RAM disk location from the one of the plurality of ad insertion systems;
transmitting the first advertisement from the RDMA requested RAM disk location to the one of the plurality of ad insertion systems;
receiving an acknowledgement from the one of the plurality of ad insertion systems, wherein the acknowledgement includes the advertisement ID and information indicating whether the first advertisement was viewed and the length of time that the first advertisement was viewed;
using the acknowledgement to determine whether to replace the first advertisement with a second advertisement in the RAM disk location matching the first advertisement category;
using the acknowledgement to determine whether to replace the first advertisement category with a second advertisement category in the RAM disk location; and
if the RAM disk location is updated to the second advertisement category, replacing the first category metadata in the multicast communication channel with second category metadata wherein the multicast communication channel allows a simultaneous update of the plurality of ad insertion systems.
